(19) United States
(12) Patent Application Publication
(10) Pub. No.: US 2023/0296886 A1
(43) Pub. Date: Sep. 21, 2023

(54) LUMINANCE COMPENSATION IN WAVEGUIDE HEAD-UP DISPLAY

(71) Applicant: GM Global Technology Operations LLC, Detroit, MI (US)

(72) Inventors: Kai-Han Chang, Madison Heights, MI (US); Thomas A, Seder, Fraser, MI (US); Joseph F. Szczerba, Grand Blanc, MI (US); John P. Weiss, Shelby Township, MI (US)

(21) Appl. No.: 17/695,041

(22) Filed: Mar. 15, 2022

(51) Int. Cl. G02B 27/01

(52) U.S. Cl. CPC G02B 27/0101; G02B 27/0179; G02B 2027/0118; G02B 2027/0187

(57) ABSTRACT

A head-up display system includes a laser adapted to project a holographic image, a spatial light modulator, an exit pupil replicator, a diffuser adapted to be positioned within a x-y plane at a center point of a vehicle eyellipse, the hologram projector adapted to project a dot pattern onto the diffuser, and a controller adapted to characterize an intensity distribution of the dot pattern, store the intensity distribution therein, acquire a location of a driver's eyes, map the location of the driver's eyes to the intensity distribution of the dot pattern, and implement corrective action based on the intensity distribution at the location of the driver's eyes.

### INTRODUCTION

The present disclosure relates to a head-up display and more particularly to a system and method for compensating for luminance variation across the eyebox in a waveguide-based holographic head-up display.

A head-up display (HUD) has become common in modern automobiles. HUDs project useful information like speed and navigation information into the driver's field of view. This avoids forcing the driver to look down, away from the road, to read gages on the dash of the automobile. This reduces driver distractions and keeps the driver's eyes on the road.

Current HUD systems do not provide the ability to measure, or compensate for luminance non-uniformity across the eyebox. When luminance non-uniformity occurs, the brightness or intensity of the image may appear different at different positions within the eyebox. New HUD systems may include projecting augmented reality images, such as optimal travel paths or navigation arrows to provide images that appear to be on the actual road surface. In such systems, a perfect waveguide-based exit pupil replicator could provide accurate prescription of reflectivity or diffraction efficiency at each replication, and ultimately deliver uniform luminance distribution across the eyebox. However, manufacturing limitations of such systems results in luminance non-uniformity.

Thus, there is a need for a new and improved method of calibrating an augmented reality HUD system to ensure the image intensity is consistent for all driver eye positions across the eyebox.

### SUMMARY

According to several aspects of the present disclosure, a head-up display system in accordance with the present disclosure includes a laser adapted to project a holographic image, a spatial light modulator, an exit pupil replicator, a diffuser adapted to be positioned within a x-y plane at a center point of a vehicle eyellipse, the hologram projector adapted to project a dot pattern onto the diffuser, and a controller adapted to characterize an intensity distribution of the dot pattern, store the intensity distribution therein, acquire a location of a driver's eyes, map the location of the driver's eyes to the intensity distribution of the dot pattern, and implement corrective action based on the intensity distribution at the location of the driver's eyes.

According to another aspect, the system further includes a camera in communication with the controller and adapted to capture the dot pattern and, with the controller, to characterize the intensity distribution of the dot pattern.

According to another aspect, the camera is further adapted to acquire the location of the driver's eyes.

According to another aspect, when implementing corrective action based on the intensity distribution at the location of the driver's eyes, the controller is further adapted to compare an intensity of the dot pattern at a location of a driver's eyes to an intensity of the dot pattern at a nominal location of the driver's eyes, and implement corrective action when the intensity of the dot pattern at the location of the driver's eyes varies from the intensity of the dot pattern at the nominal location of the driver's eyes.

According to another aspect, when implementing corrective action, the controller is further adapted to adjust the intensity of a projected image at the location of the driver's eyes to match the intensity of the projected image at the nominal location of the driver's eyes.

According to another aspect, when adjusting the intensity of the projected image at the location of the driver's eyes, the controller is further adapted to adjust the power of the laser hologram projector.

According to another aspect, when adjusting the intensity of the projected image at the location of the driver's eyes, the controller is further adapted to adjust grey levels of colors projected by the laser hologram projector.

According to another aspect, when adjusting the intensity of the projected image at the location of the driver's eyes, the controller is further adapted to adjust gamma curve of primary colors projected by the hologram projector.

According to another aspect, the controller is adapted to selectively automatically implement corrective action based on the intensity distribution at the location of the driver's eyes and to allow a driver to manually implement corrective action.

According to several aspects of the present disclosure, a method of calibrating a head up display system for an automobile includes placing a diffuser that is aligned with an x-y plane at a center point of a vehicle eyellipse, projecting, with the head up display system, a dot pattern onto the diffuser, capturing the dot pattern with a camera of a driver monitoring system that is in communication with a controller, characterizing an intensity distribution of the dot pattern with the controller, storing the intensity distribution within the controller, acquiring, with the camera, a location of a driver's eyes, mapping, with the controller, the location of the driver's eyes to the intensity distribution of the dot pattern, and implementing, with the controller, corrective action based on the intensity distribution at the location of the driver's eyes, including comparing an intensity of the dot pattern at a location of a driver's eyes to an intensity of the dot pattern at a nominal location of the driver's eyes, and implementing corrective action when the intensity of the dot pattern at the location of the driver's eyes varies from the intensity of the dot pattern at the nominal location of the driver's eyes, wherein, implementing corrective action includes adjusting the intensity of a projected image at the location of the driver's eyes by one of adjusting the power of a hologram projector of the system, adjusting grey levels of colors projected by the hologram projector, adjusting gamma curve of primary colors projected by the hologram projector, and maintaining the color coordination of the projected image with known intensity difference of three primary colors at a specific eye position by one of, adjusting the graphic grey level of the individual primary colors and adjusting the power of the hologram projector, the controller adapted to selectively automatically implement corrective action based on the intensity distribution at the location of the driver's eyes and to allow a driver to manually implement corrective action.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic illustration of a head-up display system according to an exemplary embodiment;

FIG. 2 is a graphical illustration of a diffuser with a dot pattern projected thereon and a vehicle eyellipse;

FIG. 3 is a graphical illustration of a diffuser with a dot pattern projected thereon and a schematic representation of a first driver's eyes position and a nominal driver's eyes position;

FIG. 4 is a flow chart representing a method according to an exemplary embodiment of the present disclosure.

### DETAILED DESCRIPTION

The following description is merely exemplary in nature and is not intended to limit the present disclosure, application, or uses.

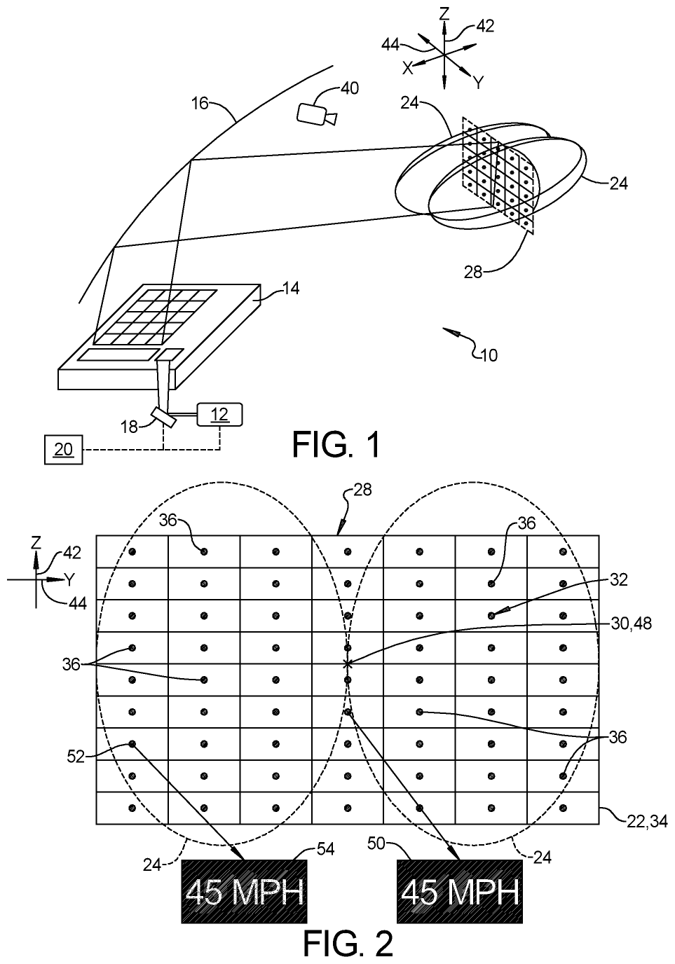

Referring to FIG. 1, a head-up display (HUD) system 10 according to the present disclosure includes a holographic projector that includes a laser 12, a spatial light modulator 18 that is adapted to project a holographic image.

In an exemplary embodiment, the system 10 includes an exit pupil replicator 14. The holographic image is projected into the exit pupil replicator 14 and then propagates inside the exit pupil replicator 14 and is extracted multiple times before being projected upward to an inner surface of a windshield 16. The re-circulation of the light several times within the exit pupil replicator 14 expands the pupil so the viewer can see the holographic image from an extended eye-box. In addition to expanding the eye-box, the exit pupil replicator 14 also magnifies the original projected image coming out of the laser 12.

A spatial light modulator 18 is positioned between the laser 12 and the exit pupil replicator 14. The spatial light modulator 18 is adapted to receive the light from the laser 12, to diffract the laser light with an encoded hologram and to deliver the diffracted laser to the exit pupil replicator 14. A controller 20 is in communication with the laser 12 and the spatial light modulator 18.

The controller 20 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

In an automobile, the controller 20 obtains information of the position of the eyes of a driver of the automobile from a camera of a driver monitoring system within the automobile. The driver monitoring system uses the camera to identify the facial features of the driver and provides information on the vertical location of the eyes of the driver to the controller 20.

The laser 12, spatial light modulator 18, and exit pupil replicator 14 are adapted to project an image upward to the windshield 16 within the automobile. The projected image reflects from an inner surface of the windshield 16 to an eyebox 22. The eyebox 22 is the three-dimensional region within which a driver of the automobile can see the entire projected image from the HUD system. An eyellipse 24 is a three-dimensional graphical depiction of a multivariate normal distribution used to approximate the distribution of driver eye locations within the automobile. The eyellipse 24 is represented by two three-dimensional ellipses, one for the right eye and one for the left eye.

The look down angle (LDA) is the angle at which the eyes of a driver are oriented relative to the virtual image projected to the eyes of the driver. The virtual image distance (VID) is the distance from the driver's eyes the virtual image is perceived by the driver. To accommodate for driver's of different heights, the LDA and the VID are adjustable to ensure the image projected by the laser hologram projector 12 is perceived at the proper location by all drivers.

In some systems, the controller 20 is adapted to determine the distance that the vertical location of the driver's eyes varies from the pre-determined nominal vertical position. Based on the distance at which the driver's eyes are either higher or lower than the nominal vertical position, the spatial light modulator 18 can adjust the LDA of the holographic image projected by the holographic projector comprising of at least one laser 12 and at least one spatial light modulator 18.

Referring again to FIG. 1, a diffuser 28 is adapted to be positioned within an x-y plane at a center point 30 of the vehicle eyellipse 24. Referring to FIG. 2, the laser 12 is adapted to project a dot pattern 32 onto the diffuser 28. The diffuser 28 may include an outer boundary box 34 to indicate the outline of the eyebox 22. The dot pattern 32 is a two-dimensional array of dots 36. The hologram projector projects the image of the dot pattern 32, and the exit pupil replicator 14 replicates the projected image to a two-dimensional dot array with planar wavefront at the same plane as the diffuser 28 and the center point 30 of the vehicle eyellipse 24.

The controller 20 is adapted to characterize an intensity distribution of the dot pattern 32. The system 10 includes a camera 40 that is in communication with the controller 20. The camera 40 is adapted to capture the dot pattern 32 and, with the controller 20, to characterize the intensity distribution of the dot pattern 32. The controller 20 measures the intensity of each of the projected dots 36 within the dot pattern 32. The intensity of the projected dot pattern 32 varies across the eyebox 22. This means that any image projected by the laser 12 will exhibit different intensity depending on where in the eyebox 22 the image is being viewed. For example, in FIG. 2, a first dot 48 of the dot pattern 32 located near the center point 30 of the eyellipse 24 exhibits the desired intensity. An image projected by the laser 12 would appear to have the correct intensity characteristics, as indicated at 50. Alternatively, a second dot 52 of the dot pattern 32 located away from the center point 30, exhibits a darker image that would be less visible and less clear to a driver, as indicated at 54.

The controller 20, using the camera 40, collects intensity data at each dot 36 of the dot pattern 32 and characterizes the intensity distribution by creating a two-dimensional model of the distribution of image intensity at each dot 36 location across the dot pattern 32, and the eyebox 22. The controller 20 stores this intensity distribution.

The laser hologram projector 12 may include individual lasers adapted to project red, green and blue light. In an exemplary embodiment, each of the red, green and blue lasers are actuated individually to create a dot pattern 32, and the camera 40 and controller 20 collect intensity data at each of the dot 36 locations of the dot pattern 32 for each of the red, green and blue lasers.

The camera 40 is further adapted to acquire a location of a driver's eyes. The camera “looks” for the driver's eyes, and once located, the controller 20 is adapted to map the location of the driver's eyes to the intensity distribution of the dot pattern 32. The controller 20 is then adapted to implement corrective action based on the intensity distribution at the location of the driver's eyes.

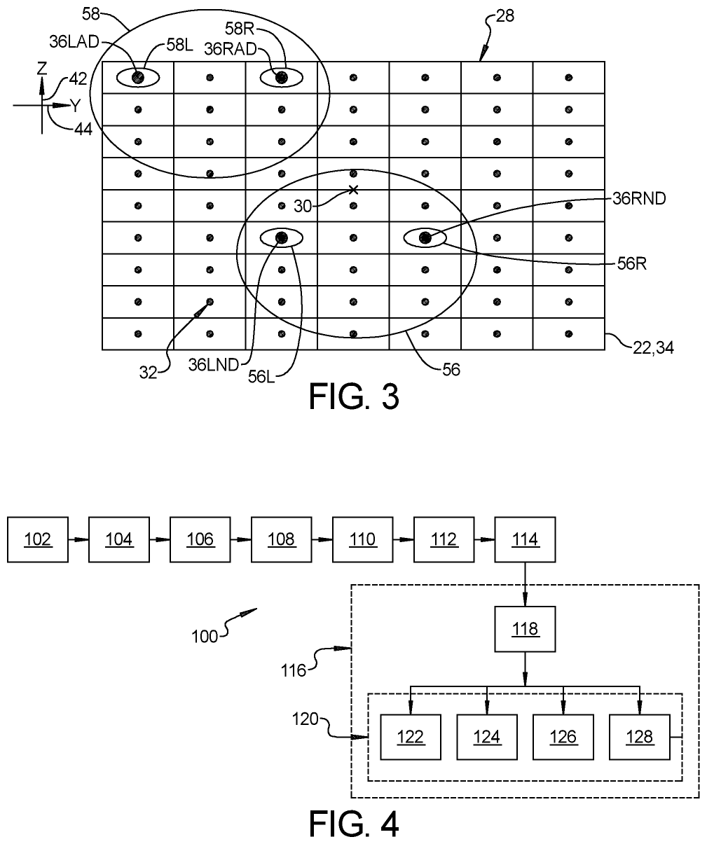

Referring to FIG. 3, the system 10 is designed for the hypothetical nominal driver 56. The nominal driver 56 would be positioned with eyes located at a nominal location. As shown, the left eye 56L of the nominal driver 56 and the right eye 56R of the nominal driver 56 are located at corresponding dots 36LND, 36RND within the dot pattern 32. The system 10 is designed so the intensity at the two dots 36LND, 36RND corresponding to the left eye 56L and right eye 56R of the nominal driver 56 have the proper desired intensity characteristics. The camera 40 acquires the position of the left eye 58L and the right eye 58R of the actual driver 58, and the controller 20 maps the position of the left eye 58L and the right eye 58R of the actual driver 58 to the intensity distribution. As shown, the left and right eyes 58L, 58R of the actual driver 58 are located at corresponding dots 36LAD, 36RAD within the dot pattern 32, spaced from the dots 36LND, 36RND corresponding to the eye locations of the nominal driver 56.

In an exemplary embodiment, when implementing corrective action based on the intensity distribution at the location of the left and right eyes 58L, 58R of the actual driver 58, the controller 20 is further adapted to compare an intensity of the dot pattern 32 at a location of left and right eyes 58L, 58R of the actual driver 58 to an intensity of the dot pattern 32 at the location of the left and right eyes 56L, 56R of the nominal driver 56. The controller 20 accesses the intensity distribution to compare the previously measured intensity of the projected dots 36LND, 36RND at the location of the nominal driver's eyes 56L, 56R to the previously measured intensity of the projected dots 36LAD, 36RAD at the location of the actual driver's eyes 58L, 58R. If the intensity distribution indicates that the expected intensity of a projected image at the location of the actual driver's eyes 58L, 58R will vary from the desired intensity at the nominal location 56L, 56R, then the controller 20 will implement corrective action.

In an exemplary embodiment, when implementing corrective action, the controller 20 is further adapted to adjust the intensity of a projected image at the location of the driver's eyes 58L, 58R to match the intensity of the projected image at the location of the nominal driver's eyes 56L, 56R. As shown in FIG. 3, for example, the expected intensity of the image at the driver's eye positions 36LAD, 36RAD is lower than the expected (desired) intensity of the image at the nominal driver eye positions 36LND, 36RND. The controller 20 will adjust the intensity of the image projected at the driver eye locations 36LAD, 36RAD to increase the intensity. There are multiple ways to accomplish this. In one exemplary embodiment, when adjusting the intensity of the projected image at the location of the driver's eyes 58L, 58R, the controller 20 is adapted to adjust the power of the laser hologram projector 12. This may entail increasing or decreasing the current applied to the laser hologram projector 12.

When a laser hologram projector 12 includes individual lasers adapted to project red, green and blue light, the controller 20 will access the intensity distribution to compare the previously measured red, green and blue intensity of the projected dots 36 at the nominal driver eye locations 36LND, 36RND to the previously measured red, green and blue intensity of the projected dots 36 at the actual driver eye locations 36LAD, 36RAD. If the intensity distribution indicates that the expected intensity of a projected image at the location of the actual driver's eyes 58L, 58R will vary from the desired intensity at the nominal driver's eye locations 36LND, 36RND, then the controller 20 will implement corrective action. In another exemplary embodiment, the controller 20 adjusts the intensity of the projected image by individually adjusting power to each of the red, green and blue lasers, to adjust the intensity of the red, green and blue light individually. In another exemplary embodiment, the corrective action may include utilizing an adaptive gamma curve of the three primary colors (red, green, blue) based on eye position via encoding the required current to each laser.

In still another exemplary embodiment, the controller 20 adjusts the intensity of the projected image at the location of the actual driver's eyes 58L, 58R by controlling the grey levels of the colors projected by the lasers. This is done by adjusting the grey levels of each color in the graphic. A corresponding hologram will be calculated and sent to the spatial light modulator 18 by the controller 20. Intensity adjustments will be made in the encoded hologram delivered to the exit pupil replicator 14.

Other corrective actions may include, maintaining color coordinate of the projected image with known intensity difference for the three primary colors at specific eye positions within the eyebox 22 by adjusting the image grey level of the individual primary colors, or by adjusting the laser 12 power level, and adjusting color contrast for graphic visibility position by adjusting the image grey level of the individual primary colors or by adjusting the laser 12 power level.

Rather than adjusting the image over the entire eyebox 22, an advantage of the system 10 of the present disclosure is that only the intensity at the location of the driver's eyes 58L, 58R is adjusted. This allows for easier and quicker adaptation of the system 10 to an individual driver.

In one exemplary embodiment, the controller 20 is adapted to selectively automatically implement corrective action based on the intensity distribution at the location of the driver's eyes 36LAD, 36RAD. A driver may selectively allow automatic adjustments, wherein the system 10 will continually monitor the position of the driver's eyes 58L, 58R, and make adjustments to the projected image as needed to ensure the driver receives the projected image at the desired intensity. Alternatively, and at the same time, the controller 20 may also be adapted to allow a driver to manually adjust the intensity of the projected image. This way, a driver may manually adjust the intensity of the projected image at the location of the driver's eyes 58L, 58R to make the projected image appear more or less intense to the driver, according to the driver's personal preference.

Referring to FIG. 4, a method 100 of compensating for luminance intensity non-uniformity in a head up display system 10 for an automobile includes, beginning at block 102, placing a diffuser 28 that is aligned with an x-y plane at a center point 30 of a vehicle eyellipse 24, moving to block 104, projecting, with the head up display system 10, a dot pattern 32 onto the diffuser 28, moving to block 106, using a camera 40 to capture the dot pattern 32, and, moving to block 108, characterizing an intensity distribution of the dot pattern 32 with a controller 20. Moving to block 110, the method 100 includes storing the intensity distribution within the controller 20.

Once a driver is seated within the automobile, moving to block 112, the method 100 includes using the camera 40 to acquire a location of the driver's eyes 58L, 58R, and, moving to block 114, mapping, with the controller 20, the location of the driver's eyes 58L, 58R to the intensity distribution of the dot pattern 32.

Moving to block 116, the method 100 includes implementing, with the controller 20, corrective action based on the intensity distribution at the location 36LAD, 36RAD of the driver's eyes 58L, 58R. The controller is adapted to selectively automatically implement corrective action based on the intensity distribution at the location 36LAD, 36RAD of the driver's eyes 58L, 58R and to allow a driver to manually implement corrective action.

In an exemplary embodiment, the implementing corrective action based on the intensity distribution at the location of the driver's eyes at block 116 further includes, moving to block 118, comparing an intensity of the dot pattern 32 at a location 36LAD, 36RAD of a driver's eyes 58L, 58R to an intensity of the dot pattern 32 at a location 36LND, 36RND of a nominal driver's eyes 56L, 56R, and, moving to block 120, implementing corrective action when the intensity of the dot pattern 32 at the location 36LAD, 36RAD, of the driver's eyes 58L, 58R varies from the intensity of the dot pattern 32 at the location 36LND, 36RND of the nominal driver's eyes 56L, 56R.

In an exemplary embodiment, the implementing corrective action at block 120 further includes adjusting the intensity of a projected image at the location 36LAD, 36RAD of the driver's eyes 58L, 58R to match the intensity of the projected image at the location 36LND, 36RND of the nominal driver's eyes 56L, 56R by, moving to block 122, adjusting the power of a laser hologram projector 12 of the system 10. In another exemplary embodiment, the implementing corrective action at block 120 further includes adjusting the intensity of a projected image at the location 36LAD, 36RAD of the driver's eyes 58L, 58R to match the intensity of the projected image at the location 36LND, 36RND of the nominal driver's eyes 56L, 56R by, moving to block 124, adjusting grey levels of colors projected by the laser hologram projector 12.

In still another exemplary embodiment, the implementing corrective action at block 120 further includes, moving to block 126, adjusting gamma curve of primary colors projected by the hologram projector 12, and in yet another exemplary embodiment, the implementing corrective action at block 120 further includes, moving to block 128, maintaining the color coordination of the projected image with known intensity difference of three primary colors at a specific eye position by one of, adjusting the graphic grey level of the individual primary colors and adjusting the power of the hologram projector 12.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of compensating for luminance intensity non-uniformity in a head up display system for an automobile, comprising:
placing a diffuser that is aligned with an x-y plane at a center point of a vehicle eyellipse;
projecting, with the head up display system, a dot pattern onto the diffuser;
characterizing an intensity distribution of the dot pattern with a controller;
storing the intensity distribution within the controller;
acquiring a location of a driver's eyes;
mapping, with the controller, the location of the driver's eyes to the intensity distribution of the dot pattern; and
implementing, with the controller, corrective action based on the intensity distribution at the location of the driver's eyes.

2. The method of claim 1, further including using a camera to capture the dot pattern and, with the controller, to characterize the intensity distribution of the dot pattern.

3. The method of claim 2, further including using the camera to acquire the location of the driver's eyes.

4. The method of claim 3, wherein the camera is a camera of a driver monitoring system.

5. The method of claim 4, wherein the implementing corrective action based on the intensity distribution at the location of the driver's eyes further includes:
comparing an intensity of the dot pattern at a location of a driver's eyes to an intensity of the dot pattern at a nominal location of the driver's eyes; and
implementing corrective action when the intensity of the dot pattern at the location of the driver's eyes varies from the intensity of the dot pattern at the nominal location of the driver's eyes.

6. The method of claim 5, wherein the implementing corrective action further includes adjusting the intensity of a projected image at the location of the driver's eyes to match the intensity of the projected image at the nominal location of the driver's eyes.

7. The method of claim 6, wherein the adjusting the intensity of the projected image at the location of the driver's eyes, includes adjusting the power of a hologram projector of the system.

8. The method of claim 6, wherein the adjusting the intensity of the projected image at the location of the driver's eyes includes adjusting grey levels of colors projected by the hologram projector.

9. The method of claim 6, wherein the adjusting the intensity of the projected image at the location of the driver's eyes includes adjusting gamma curve of primary colors projected by the hologram projector.

10. The method of claim 4, wherein the controller is adapted to selectively automatically implement corrective action based on the intensity distribution at the location of the driver's eyes and to allow a driver to manually implement corrective action.

11. A head-up display system, comprising:
At least one laser adapted to project a holographic image;
at least one spatial light modulator;
an exit pupil replicator;
a diffuser adapted to be positioned within a x-y plane at a center point of a vehicle eyellipse, the hologram projector adapted to project a dot pattern onto the diffuser; and
a controller adapted to:
characterize an intensity distribution of the dot pattern;
store the intensity distribution therein;
acquire a location of a driver's eyes;
map the location of the driver's eyes to the intensity distribution of the dot pattern; and
implement corrective action based on the intensity distribution at the location of the driver's eyes.

12. The system of claim 11, further including a camera in communication with the controller and adapted to capture the dot pattern and, with the controller, to characterize the intensity distribution of the dot pattern.

13. The system of claim 12, wherein the camera is further adapted to acquire the location of the driver's eyes.

14. The system of claim 13, wherein, when implementing corrective action based on the intensity distribution at the location of the driver's eyes, the controller is further adapted to:
compare an intensity of the dot pattern at a location of a driver's eyes to an intensity of the dot pattern at a nominal location of the driver's eyes; and
implement corrective action when the intensity of the dot pattern at the location of the driver's eyes varies from the intensity of the dot pattern at the nominal location of the driver's eyes.

15. The system of claim 14, wherein, when implementing corrective action, the controller is further adapted to adjust the intensity of a projected image at the location of the driver's eyes to match the intensity of the projected image at the nominal location of the driver's eyes.

16. The system of claim 15, wherein, when adjusting the intensity of the projected image at the location of the driver's eyes, the controller is further adapted to adjust the power of the laser hologram projector.

17. The system of claim 15, wherein, when adjusting the intensity of the projected image at the location of the driver's eyes, the controller is further adapted to adjust grey levels of colors projected by the laser hologram projector.

18. The system of claim 15, wherein, when adjusting the intensity of the projected image at the location of the driver's eyes, the controller is further adapted to adjust gamma curve of primary colors projected by the hologram projector.

19. The system of claim 13, wherein the controller is adapted to selectively automatically implement corrective action based on the intensity distribution at the location of the driver's eyes and to allow a driver to manually implement corrective action.

20. A method of calibrating a head up display system for an automobile, comprising:
placing a diffuser that is aligned with an x-y plane at a center point of a vehicle eyellipse;
projecting, with the head up display system, a dot pattern onto the diffuser;
capturing the dot pattern with a camera of a driver monitoring system that is in communication with a controller;
characterizing an intensity distribution of the dot pattern with the controller;
storing the intensity distribution within the controller;
acquiring, with the camera, a location of a driver's eyes;
mapping, with the controller, the location of the driver's eyes to the intensity distribution of the dot pattern; and
implementing, with the controller, corrective action based on the intensity distribution at the location of the driver's eyes, including comparing an intensity of the dot pattern at a location of a driver's eyes to an intensity of the dot pattern at a nominal location of the driver's eyes, and implementing corrective action when the intensity of the dot pattern at the location of the driver's eyes varies from the intensity of the dot pattern at the nominal location of the driver's eyes;
wherein, implementing corrective action includes adjusting the intensity of a projected image at the location of the driver's eyes by one of:
adjusting the power of a hologram projector of the system;
adjusting grey levels of colors projected by the hologram projector;
adjusting gamma curve of primary colors projected by the hologram projector; and
maintaining the color coordination of the projected image with known intensity difference of three primary colors at a specific eye position by one of, adjusting the graphic grey level of the individual primary colors and adjusting the power of the hologram projector;
the controller adapted to selectively automatically implement corrective action based on the intensity distribution at the location of the driver's eyes and to allow a driver to manually implement corrective action.
